(19) United States
(12) Patent Application Publication
(10) Pub. No.: US 2004/0128995 A1
(43) Pub. Date: Jul. 8, 2004

(54) Master cylinder comprising replenishing grooves

(76) Inventors: Juan Simon Bacardit, Barcelone (ES); Bruno Berhomieu, Barcelone (ES); Fernando Sacristan, Barcelone (ES)

Correspondence Address: Leo H McCormick Jr, 2112 Mishawaka Avenue, PO Box 4721, South Bend, IN, 46634-4721, US

(21) Appl. No.: 10/469,459

(22) PCT Filed: Jan. 25, 2002
(86) PCT No.: PCT/FR02/00320

(30) Foreign Application Priority Data
Feb. 8, 2001 (FR) 01 01895

(51) Int. Cl. F15B 7/10

(52) U.S. Cl. 60/592

(57) ABSTRACT

A brake master cylinder having a bore with a front portion for receiving and guiding a piston and arranged forward of a front sealing arrangement. The sealing arrangement includes at least one groove that establishes communication between a front chamber and a reservoir to allow, as the piston retreats towards its position of rest, the resupply of fluid through a radial supply duct from the reservoir.

The invention relates to a brake master cylinder for a motor vehicle.

The invention relates more specifically to a brake master cylinder for a motor vehicle, of the type which comprises a practically axial body inside a bore of which is slidably mounted at least one axial piston which can be actuated by a driver of the vehicle between a rear position of rest and a forward position of applying a braking force, of the type in which the bore comprises two sealing means, front and rear, which are interposed between the piston and the bore, the front sealing means delimiting within the bore a rear supply chamber and a front pressure chamber, of the type in which the body comprises a radial supply duct which connects an external reservoir of hydraulic fluid to the rear supply chamber and which opens between the two sealing means of the type in which the body comprises a supply drilling for a braking circuit which opens into the front pressure chamber, of the type which comprises means placing the front pressure chamber and the rear supply chamber in communication, which means are able to be inhibited by the piston when it is moved axially forwards towards its position of application so as to isolate the front pressure chamber from the rear supply chamber and thus make it possible for a braking pressure to be established in the front pressure chamber, of the type in which the front sealing means is able to allow hydraulic fluid to pass as the piston retreats towards its position of rest.

Numerous examples of brake master cylinders of this type are known.

In most master cylinders of this type, the piston is slidably mounted directly in the bore and at least one of the two sealing means, formed of a seal, is carried by the piston.

This design has numerous disadvantages. In the first place, the piston having [lacuna] guided over practically its entire length in the bore, it is necessary, when machining the bore of the body and when machining the piston, to match the piston to the bore which determines both satisfactory guiding of the piston in the bore, correct sealing of the sealing means, and that there is enough clearance to allow the hydraulic fluid from the front pressure chamber, as the piston retreats towards its position of rest, to infiltrate between the piston and the bore so as to deform the lip of the seal to resupply the radial duct and the reservoir.

Such machining operations are therefore very expensive to perform and, what is more, they do not guarantee effective flow of the hydraulic fluid.

To remedy this drawback, the invention provides a brake master cylinder of the aforementioned type which comprises means for allowing the fluid to flow between the chamber and the radial duct, the effectiveness of which is independent of the manufacturing tolerances on the body and the piston.

To this end, the invention provides a brake master cylinder of the aforementioned type, characterized in that the bore comprises a front portion for guiding the piston, arranged forward of the front sealing means which comprises at least one groove which establishes communication between the front chamber and the front sealing means so as to allow, as the piston retreats towards its position of rest, the resupply of the radial supply duct and of the reservoir.

According to other features of the invention:

the bore comprises at least one rear portion for guiding the piston, which is arranged between the front sealing means and the radial supply duct, and which comprises at least one groove which establishes communication between the front sealing means and the radial duct so as to allow, as the piston retreats towards its position of rest, the resupply of the radial supply duct and of the reservoir,

the grooves are helical,

each portion, front and/or rear, comprises a number of grooves,

the front and rear guide portions consist respectively of front and rear annular bearing surfaces which project into the bore and each of which has an inside diameter practically corresponding to that of the piston,

the front sealing means consist of a front seal which is mounted in a groove of the body and an interior peripheral lip of which, arranged in contact with the piston, is able to lift the piston when it returns from its position of application to its position of rest, so as to allow the hydraulic fluid, by flowing between the bore and the piston, to resupply the radial supply duct and the reservoir,

the piston comprises, at its end, an external elastic ring which is capable, when the piston is in the position of rest, of coming into contact with a front shoulder face of the front annular bearing surface to form an end stop,

the piston is returned elastically to its rear position of rest by a spring, and

the master cylinder is a master cylinder of the “tandem” type which comprises, from the rear forwards, two pistons, primary and secondary, which delimit, within the bore of the body, a primary and a secondary supply chamber, and a primary and a secondary pressure chamber, the primary piston being returned elastically to its rear position of rest by a spring bearing between a rear face of the secondary piston and a front face of the primary piston.

Other features and advantages of the invention will become apparent from reading the detailed description which follows, for an understanding of which reference will be made to the appended drawings.

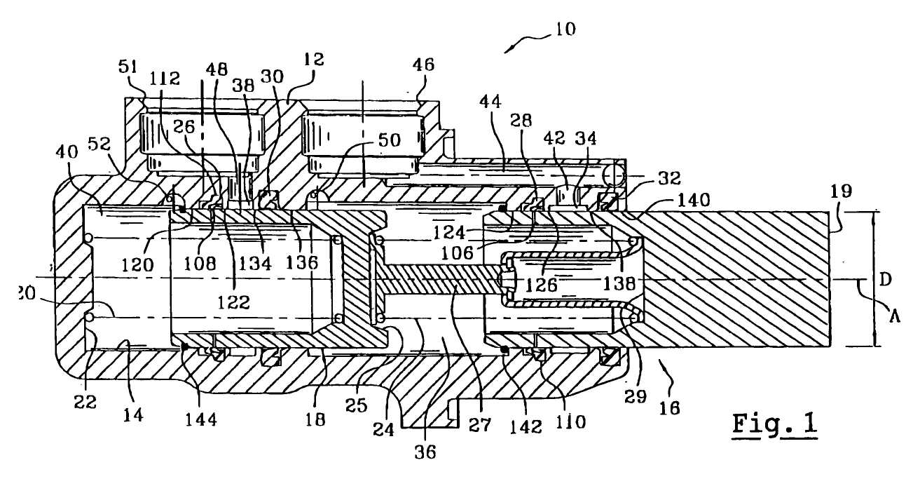

FIG. 1 is a view in axial section of a master cylinder of the “tandem” type according to the invention, depicted in the position of rest;

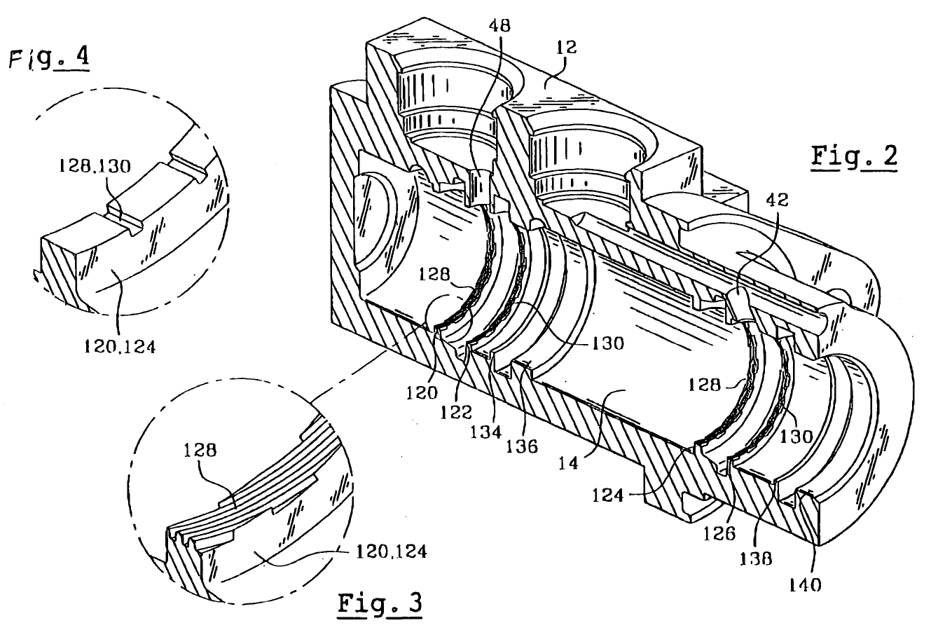

FIG. 2 is a perspective half view of the body of the master cylinder;

FIG. 3 is a detail of the grooves according to a preferred embodiment of the invention; and

FIG. 4 is a detail of the grooves according to an alternative form of embodiment of the invention.

In the description which will follow, identical reference numerals denote parts which are identical or have similar functions.

By convention, the terms “front” and “rear” respectively denote elements or positions directed respectively towards the left and towards the right in the figures.

FIG. 1 depicts a motor vehicle brake master cylinder assembly 10.

In a known way, in the preferred embodiment of the invention, the master cylinder 10 is a master cylinder of the “tandem” type which comprises a practically axial body 12 of axis A, inside a bore 14 of which are slidably mounted two axial pistons 16 and 18.

This configuration is not, however, a limitation on the invention and the master cylinder 10 could be a simple master cylinder having just one sliding piston.

The piston 16 known as the primary piston 16 is intended to allow a hydraulic pressure to become established in a primary braking circuit of the vehicle (not depicted), and the piston 18 known as the secondary piston 18 is intended to allow a hydraulic pressure to become established in a secondary braking circuit of the vehicle (not depicted) which is independent of the primary braking circuit of the vehicle.

The primary piston 16 is able to be actuated directly by a driver of the vehicle. For example, a rear end 19 of the primary piston 16 is able to be connected to a booster (not depicted) which boosts the forces exerted on a brake pedal of the vehicle.

The secondary piston 18 is able to be actuated indirectly by the driver of the vehicle, particularly via the primary piston 16, in a way which will be described in greater detail later on.

Each piston, primary 16 or secondary 18, is thus able to move between a rear position of rest in which the pistons 16, 18 occupy a position towards the right of FIG. 1, and a forward position of applying a brake force (to the left in FIG. 1, not depicted), in which they slide in the bore 14.

In a known way, each primary 16 or secondary 18 piston is returned elastically towards its rear position of rest against an end stop which is formed in the body 14 and which will be described later on.

In particular, the secondary piston 18 is returned towards the rear by a spring 20 which bears against a transverse front end face 22 of the bore 14 and on the secondary piston 18, and the primary piston 16 is returned elastically towards the rear by a spring 24 which bears between a transverse rear face 25 of the secondary piston 18 and a front face 29 of the primary piston 16. More specifically, as the spring 24 is particularly long, it is mounted around a sliding ram 27 which is inserted between the transverse rear face 25 of the secondary piston 18 and the primary piston 16.

The bore 14 comprises two primary sealing means, front 28 and rear 32, which are inserted respectively between the primary piston 16 and the bore 14 and two secondary sealing means, front 26 and rear 30, which are interposed respectively between the secondary piston 18 and the bore 14.

As a result, the front primary sealing means 28 delimits, in the bore 14, a rear supply chamber 34 and a front pressure chamber 36. Likewise, the front secondary sealing means 28 delimits in the bore 14 a rear supply chamber 38 and a front pressure chamber 40.

The body 12 comprises a primary radial supply duct 42 which connects a primary external reservoir (not depicted) of hydraulic fluid to the primary rear supply chamber 34 and which opens between the two primary sealing means 28 and 32.

In particular, the primary radial duct 42 is, for example, connected via an intermediate longitudinal duct 44 to an orifice 46 which opens to the outside of the body 12 and which is intended to take an outlet (not depicted) of the associated primary reservoir.

Similarly, the body 12 comprises a secondary radial supply duct 48 which opens between the two secondary sealing means 26 and 30, that is to say into the secondary rear supply chamber 38, and which opens to the outside of the body 12 via an orifice 51 intended to receive an outlet (not depicted) of an associated secondary reservoir.

The body comprises two drillings, primary 50 and secondary 52, for supplying the associated primary and secondary braking circuits and which open into the associated primary 36 and secondary 40 front pressure chambers.

In a known way, the master cylinder 10 comprises means of placing each primary 36 and secondary 40 front pressure chamber in communication with the associated primary 34 and secondary 38 rear supply chamber. These communication means are able to be inhibited by the associated primary 16 and secondary 18 piston when it is moved axially forwards towards its position of application for isolating the primary 36 or secondary 40 front pressure chamber from the associated primary 34 or secondary 38 rear supply chamber, and thus allow a braking pressure to become established in the associated primary 36 or secondary 40 front pressure chamber.

According to a preferred but nonlimiting embodiment of the invention, each piston 16, 18 is made of one piece and is, in particular, tubular. To form the communication means, each piston 16, 18 comprises at least one duct 106, 108, a first end of which opens into the front pressure chamber 36, 40 and a second end of which opens into the periphery of the piston 16, 18 so as to communicate with the supply chamber 34, 38 when the piston 16, 18 is in the position of rest and serves to communicate with the front pressure chamber 36, 40 when the piston is in the position of application. In that way, when each piston 16, 18 is in the position of rest, the duct 106, 108 is arranged axially at the rear supply chamber 34, 38 and, when the piston 16, 18 is in the advanced position (not depicted), the duct 106, 108 is arranged axially at the front pressure chamber, that is to say on the other side of the front sealing means 28, 26 with respect to the position of rest of the piston 16, 18, which therefore allows the associated front pressure chamber 36, 40 to be isolated and thus allow the pressure of the hydraulic fluid to rise.

In the preferred embodiment of the invention, and without in any way limiting the latter, the front sealing means 28, 26 consists of a front seal 28, 26 which is mounted in a groove 110, 112 associated with the body 12.

An interior peripheral lip of the front seal 28, 26, arranged in contact with the piston 16, 18, is able to lift the piston 16, 18 when it retreats from its position of application towards its position of rest. This configuration allows the hydraulic fluid, by passing between the bore 14 and the piston 16, 18, to resupply the reservoir radial resupply duct 42, 48.

What happens is that, when the driver releases his force on the end 19 of the primary piston 16, the two pistons 16 and 18 retreat rapidly and a depression is created in the primary 36 and secondary 40 front pressure chambers. This depression is capable of lifting the lips of the seals 26 and 28, and this allows the hydraulic fluid to pass from the front pressure chamber 36, 40 to the duct 42, 48 by flowing between the bore 14 and the periphery of the piston 16, 18, and therefore to resupply the radial ducts 42, 48 and the associated reservoirs.

In a conventional master cylinder, the piston 16, 18 is guided directly in the bore of the body, and the hydraulic fluid is able, as the piston retreats, to infiltrate between the periphery of the piston 16, 18 and the cylindrical bore 14.

The flow of fluid is therefore directly dependent on the radial clearance there is between the piston 16, 18 and the cylindrical bore 14, this clearance itself being dependent on the matching achieved between the piston 16, 18 and the bore 14 during the respective machining operations on the same piston 16, 18 and on the bore 14.

Now, this radial clearance is necessarily small because the bore 14 has to be able to provide the piston 16, 18 with very precise guidance. As a result, this radial clearance does not allow satisfactory flow of hydraulic fluid between the piston 16, 18 and the bore 14.

As illustrated more specifically by FIGS. 2 to 4, to overcome this disadvantage, the master cylinder according to the invention comprises a guiding front portion 120, 124 which is arranged in front of the front sealing means 26, 28 and which comprises at least one groove 128 which establishes a communication between the front chamber 40, 36 and the front sealing means 26, 28 so as to allow, as the piston 16, 18 retreats towards its position of rest, the resupply of the radial supply duct 42, 48 and of the associated reservoir.

This configuration allows the radial duct 42, 48 to be resupplied satisfactorily independently of the functional clearance there is between the piston 16, 18 and the bore 14, and more specifically between the piston 16, 18 and the guiding front portion 120, 124.

Advantageously, the bore comprises at least one rear portion 122, 126 for guiding the piston 16, 18, which is arranged between the front sealing means 26, 28 and the radial supply duct 42, 48 and which comprises at least one groove 130 similar to the previously mentioned groove(s) 128, for establishing communication between the front sealing means 26, 28 and the radial duct 42, 48 so as to allow, as the piston 16, 18 retreats towards its position of rest, the resupply of the radial supply duct 42, 48 and of the reservoir.

In the preferred embodiment of the invention, the guiding front 120, 124 and rear 122, 126 portions consist respectively of front and rear annular bearing surfaces which project into the bore 14 and each of which has an inside diameter “D” practically corresponding to that of the piston 16, 18.

Furthermore, the body comprises a rear pair of annular bearing surfaces 134, 136 which are arranged on each side of a rear seal 30 forming the rear sealing means associated with the piston 18 and a rear pair of annular bearing surfaces 138, 140 which are arranged on each side of a rear seal 32 forming the rear sealing means associated with the piston 16. These bearing surfaces 134, 136, 138, 140 guide the associated pistons 16, 18 in the bore 14.

This configuration is particularly advantageous because it makes it possible to limit the contact of the piston 16, 18 to only the annular bearing surfaces 120, 122, 124, 126, 134, 136, 138, 140, and this, on the one hand, considerably reduces the friction between the piston 16, 18 and the bore 14 and, on the other hand, allows the piston 16, 18 and the bearing surfaces 120, 122, 124, 126, 134, 136, 138, 140 to be machined to far less strict manufacturing dimensions than a conventional master cylinder while at the same time offering precise guidance of the piston 16, 18. This configuration additionally allows the radial duct 42, 48 to be resupplied with a satisfactory flow rate.

The grooves 128, 130 are depicted more specifically in FIGS. 3 and 4.

According to a preferred embodiment of the invention, the grooves 128, 130 are helical, as depicted in FIGS. 3 and 4. This arrangement does not, however, restrict the invention, and the grooves 128, 130 could be practically axial, as depicted in FIG. 4.

In the preferred embodiment of the invention, each front 120, 124 and/or rear 122, 126 annular bearing surface comprises a number of associated grooves 128, 130.

In particular, in the preferred embodiment of the invention which is depicted in FIG. 3, the helical grooves 128, 130 all have the same pitch, so as to encourage swirling flow of the hydraulic fluid.

In the alternative form of embodiment of the invention, which is depicted in FIG. 4, the axial grooves 128, 130 are arranged at uniform angular intervals along the surface of the associated bearing surface 120, 122, 124, 126 in such a way as to make the hydraulic fluid flow uniformly.

Finally, as illustrated in FIG. 1, the end stop means for the pistons 16, 18 comprise, at the end of each piston 16, 18, an external elastic ring 142, 144 which is able, when the piston 16, 18 is in the position of rest, to come into contact with a front shoulder face of the associated front annular bearing surface 124, 120. This configuration therefore advantageously allows the front annular bearing surfaces 124, 120 to produce end stop means for the pistons 16 and 18 which are simple and inexpensive to manufacture.

The invention therefore makes it possible to have a master cylinder which guarantees satisfactory resupply of the radial ducts 42, 48 as the pistons 16, 18 retreat.

We claim:

1. A brake master cylinder (10) for a motor vehicle, of the type which comprises a practically axial body (12) inside a bore (14) of which is slidably mounted at least one axial piston (16, 18) which can be actuated by a driver of the vehicle between a rear position of rest and a forward position of applying a braking force, of the type in which the bore (14) comprises two sealing means, front (26, 28) and rear (30, 32), which are interposed between the piston (16, 18) and the bore (14), the front sealing means (26, 28) delimiting within the bore (14) a rear supply chamber (34, 38) and a front pressure chamber (36, 40), of the type in which the body (12) comprises a radial supply duct (42, 48) which connects an external reservoir of hydraulic fluid to the rear supply chamber (34, 38) and which opens between the two sealing means (26, 28, 30, 32) of the type in which the body (12) comprises a supply drilling (50, 52) for a braking circuit which opens into the front pressure chamber (36, 40), of the type which comprises means (106, 108) placing the front pressure chamber (36, 40) and the rear supply chamber (34, 38) in communication, which means are able to be inhibited by the piston (16, 18) when it is moved axially forwards towards its position of application so as to isolate the front pressure chamber (36, 40) from the rear supply chamber (34, 38) and thus make it possible for a braking pressure to be established in the front pressure chamber (36, 40), of the type in which the front sealing means (26, 28) is able to allow hydraulic fluid to pass as the piston (16, 18) retreats towards its position of rest, characterized in that the bore (14) comprises a front portion (120, 124) for guiding the piston (16, 18), arranged forward of the front sealing means (26, 28) which comprises at least one groove (128) which establishes communication between the front chamber (36, 40) and the front sealing means (26, 28) so as to allow, as the piston (16, 18) retreats towards its position of rest, the resupply of the radial supply duct (42, 48) and of the reservoir.

2. The master cylinder (10) according to claim 1, characterized in that the bore (14) comprises at least one rear portion (122, 126) for guiding the piston, which is arranged between the front sealing means (26, 28) and the radial supply duct (42, 48), and which comprises at least one groove (130) which establishes communication between the front sealing means (26, 28) and the radial duct (42, 48) so as to allow, as the piston (16, 18) retreats towards its position of rest, the resupply of the radial supply duct (42, 48) and of the reservoir.

3. The master cylinder (10) according to claim 2, characterized in that the grooves (128, 130) are helical.

4. The master cylinder according to claim 3, characterized in that each portion, front (120, 124) and/or rear (122, 126), comprises a number of grooves (128, 130).

5. The master cylinder (10) according to claim. 4, characterized in that the front (120, 124) and rear (122, 126) guide portions consist respectively of front (120, 124) and rear (122, 126) annular bearing surfaces which project into the bore (14) and each of which has an inside diameter (D) practically corresponding to that of the piston (16, 18).

6. The master cylinder (10) according to claim 5, characterized in that the front sealing means consist of a front seal (26, 28) which is mounted in a groove (110, 112) of the body (12) and an interior peripheral lip of which, arranged in contact with the piston (16, 18), is able to lift the piston (16, 18) when it returns from its position of application to its position of rest, so as to allow the hydraulic fluid, by flowing between the bore (14) and the piston (16, 18), to resupply the radial supply duct (42, 48) and the reservoir.

7. The master cylinder (10) according to claim 6, characterized in that the piston (16, 18) comprises, at its end, an external elastic ring (142, 144) which is capable, when the piston (16, 18) is in the position of rest, of coming into contact with a front shoulder face of the front annular bearing surface (120, 124) to form an end stop.

8. The master cylinder (10) according to claim 7, characterized in that the piston (16, 18) is returned elastically to its rear position of rest by a spring (20, 24).

9. The master cylinder (10) according to claim 8, characterized in that it is a master cylinder of the “tandem” type which comprises, from the rear forwards, two pistons, primary (16), 18) and secondary, which delimit, within the bore of the body, a primary (34) and a secondary (38) supply chamber, and a primary (36) and a secondary (40) pressure chamber, the primary piston (16) being returned elastically to its rear position of rest by a spring (24) bearing between a rear face (25) of the secondary piston (18) and a front face (29) of the primary piston (16).
